(19) United States
(12) Patent Application Publication
(10) Pub. No.: US 2013/0061180 A1
(43) Pub. Date: Mar. 7, 2013

(54) ADJUSTING A SETTING WITH A SINGLE MOTION

(71) Applicants: Niels van Dongen, Orcas, WA (US); Richie Fang, Bellevue, WA (US); Vincent Celie, Seattle, WA (US); Bennett Hornbostel, Seattle, WA (US); Jianming Zheng, Redmond, WA (US)

(72) Inventors: Niels van Dongen, Orcas, WA (US); Richie Fang, Bellevue, WA (US); Vincent Celie, Seattle, WA (US); Bennett Hornbostel, Seattle, WA (US); Jianming Zheng, Redmond, WA (US)

(73) Assignee: MICROSOFT CORPORATION, Redmond, WA (US)

(21) Appl. No.: 13/225,445

(22) Filed: Sep. 4, 2011

(51) Int. Cl. G06F 3/048

(52) U.S. Cl. 715/847

(57) ABSTRACT

Methods and systems for adjusting a device setting in response to a single motion are provided herein. The method includes initiating a user interface in response to a tap down on a device setting icon without releasing. The method also includes adjusting a device setting in response to a dragging or sliding on the device setting icon without releasing. The method further includes confirming the device setting by releasing once a desired device setting level has been attained.

### BACKGROUND

Popular methods for adjusting certain settings on devices, such as volume and brightness settings, currently employ a series of motions. For example, the traditional fly-out model requires a user to tap down and release on a touch input or other pointing device at the location of a particular device setting icon to engage a fly-out relating to the particular device setting. A fly-out is a type of sub-menu navigation that appears on a device's screen when a user taps down on, or hovers over, the corresponding main menu item. A fly-out is similar to a right-click menu, except a fly-out may appear anywhere within the vicinity (for example, to the side, above, or below) of the invocation point of a clicked item on a screen, instead of only below the item. Once the fly-out is engaged, the user may release the clicked item and place a finger over the device setting icon using a touch input or pointing device to adjust the setting. Once the desired device setting level has been reached, the user may dismiss the fly-out by clicking and releasing on the screen anywhere outside of the fly-out. However, the requirement to perform a series of motions each time a user desires to adjust a particular device setting may become time-consuming and repetitive for users who are continuously adjusting such device settings.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

An embodiment provides a method for adjusting a device setting in response to a single motion. The method includes initiating a user interface in response to a tap down on a device setting icon without releasing. The method also includes adjusting a device setting in response to a dragging or sliding on the device setting icon without releasing. The method further includes confirming the device setting by releasing once a desired device setting level has been attained.

Another embodiment provides a system for adjusting a device setting in response to a single motion. The quick scrub system includes a processor configured to implement setting adjustment modules. The modules include a user interface initiation module configured to initiate a user interface in response to a press without releasing on a device setting icon, wherein the user interface comprises a slider. The setting adjustment modules also include a device setting adjustment module configured to adjust a device setting in response to a dragging or sliding on the slider without releasing. The setting adjustment modules further include a device setting confirmation module configured to confirm the device setting by releasing the slider once a desired device setting level has been attained.

Further, another embodiment provides one or more non-volatile computer-readable storage media for storing computer readable instructions. The computer-readable instructions provide a setting adjustment system for adjusting a device setting in response to a single motion when executed by one or more processing devices. The computer-readable instructions include code configured to initiate a user interface in response to a tap down without releasing on a device setting icon, adjust a device setting in real-time in response to a sliding without releasing on the device setting icon, set the device setting at a desired device setting level by releasing the device setting icon, and abort the user interface upon release of the device setting icon.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a system for adjusting device settings in response to a single motion;

FIG. 2 is a process flow diagram showing a method for adjusting device settings in response to a single motion;

FIG. 3 is a schematic illustrating a method for adjusting a volume setting of a device in response to a single, continuous motion on a volume icon;

FIG. 4 is a schematic illustrating a method for adjusting a color setting of a device in response to a single, continuous motion on a color spectrum icon; and

FIG. 4 is a block diagram showing a non-transitory computer-readable storage medium that stores code adapted to adjust device settings in response to a single motion.

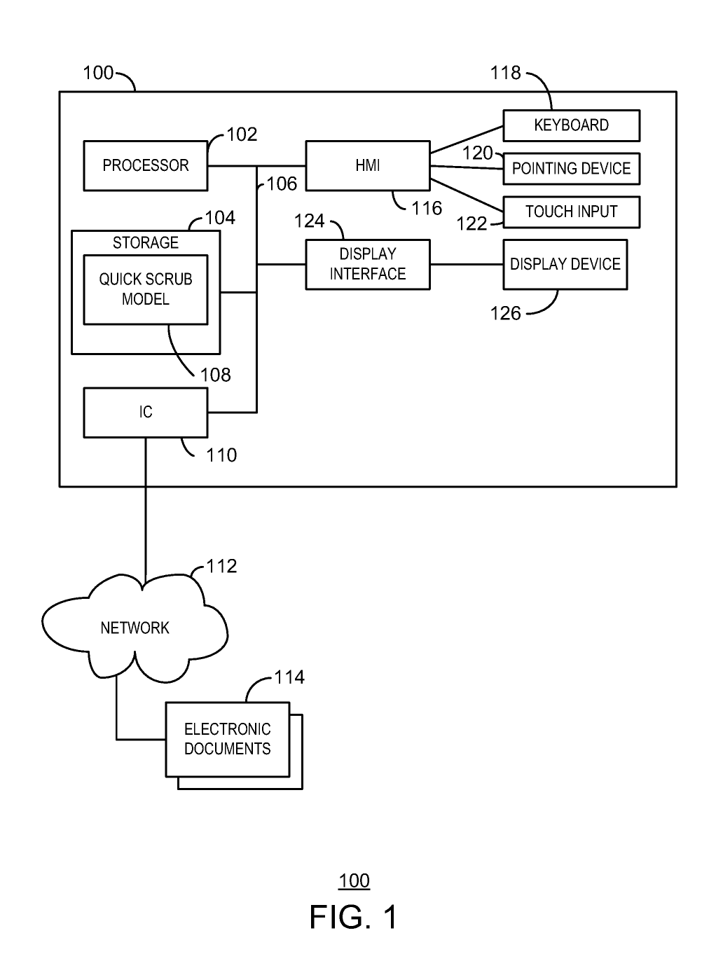

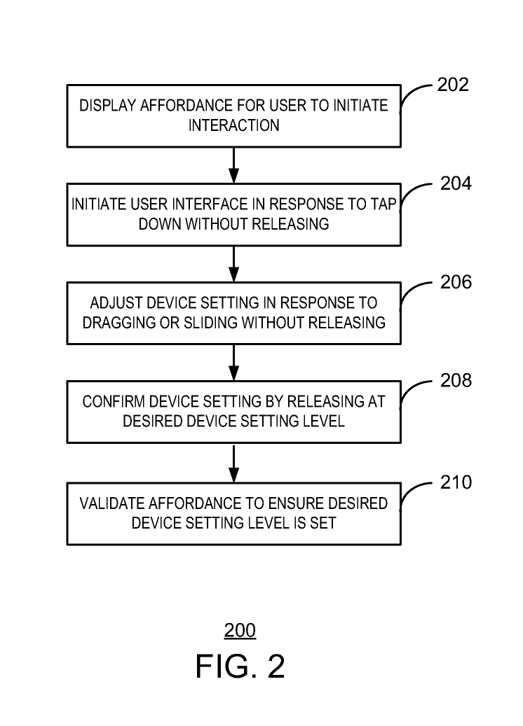

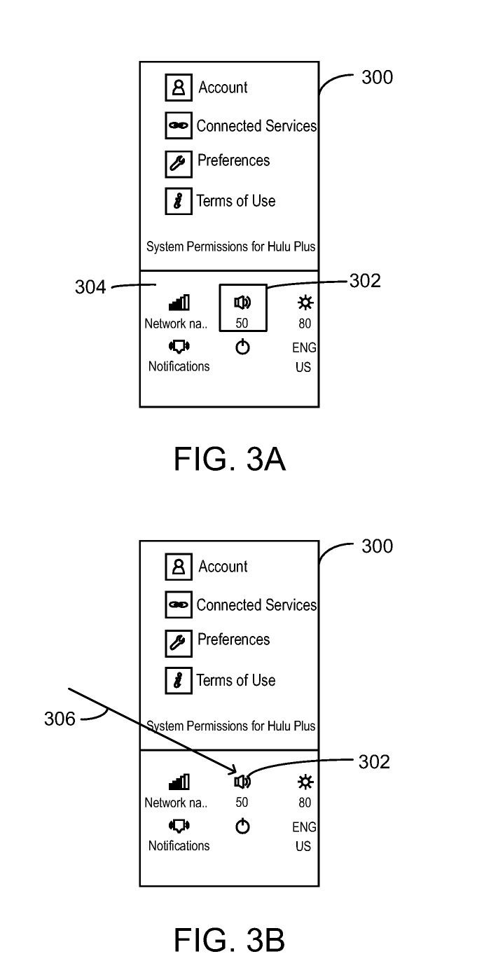

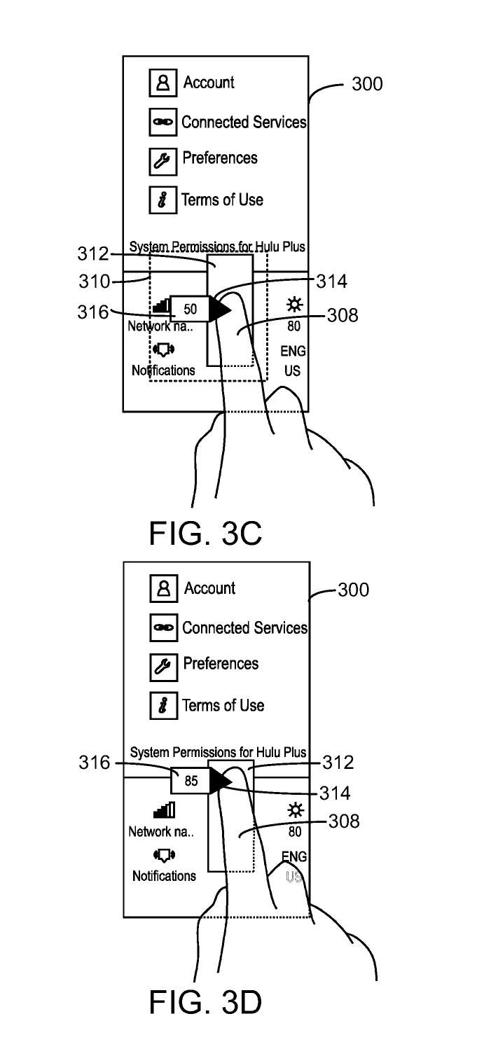

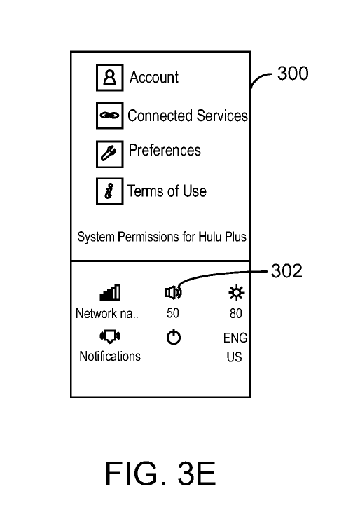

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

As discussed above, users who adjust certain device settings on a regular basis may find the traditional fly-out model to be time-consuming and repetitive. Therefore, embodiments disclosed herein set forth a method and system for adjusting device settings such as volume and brightness with one single, or continuous, motion. More generally, any device setting that has uniform and contiguous values, such as color spectrum settings, font size settings, and brush size settings, for example, may also be adjusted using the current system and method. In addition, it should be understood that the term “device setting” as used herein may include both system and non-system settings of a device. The current system and method may adjust device settings in response to a touch input or the movement of a pointing device.

The particular device setting to be adjusted may be selected by clicking on, or tapping down on, the particular device setting icon. For example, to adjust the volume setting of a device, a finger or stylus may be used to tap down on the speaker icon of the device's screen. Therefore, each device setting may be adjusted by tapping down or clicking on specific target icons positioned at different locations on the device's display screen.

Devices which may be used in conjunction with the current system and method include, but are not limited to, a laptop computer, desktop computer, television, mobile device, cellular telephone, touchpad, imaging device, interactive display or kiosk, camera-based interface device, or gaming device. The touch input employed by the current system may be a touchscreen or touchpad, among others. The touch input may be controlled using a finger, stylus, or any other type of touch manipulator. The pointing device may be a mouse, trackball, pointing stick, or joy stick, among others.

The method and system disclosed herein may be referred to as a “quick scrub model.” A scrub model is a computer model that allows for the easy adjustment of a particular device setting in response to gestural input, i.e. touch input, or the movement of a pointing device in one continuous motion. The current method and system is referred to a “quick scrub model” because it allows for the adjustment of a device setting in response to a single finger motion or movement of a mouse, for example. A particular device setting may be adjusted, for example, in response to a user tapping down and holding on the device setting icon, dragging, and releasing using a touch manipulator on a touch input or a pointing device.

As discussed above, the quick scrub system may employ three general stages: tap down, drag, and release. In an embodiment, a user interface may appear beneath a user's finger in response to a user tapping down and holding on a device setting icon using a touch manipulator on a touch input. A user interface is a system by which a human, or user, may interact with a machine. A user interface may allow a user to manipulate a system through input and also allow a system to respond to the input of the user to produce an output.

For most applications, the user interface may appear almost immediately. The user interface may consist of a fly-out that hosts a slider, including a slider track and slider nub. As used herein, a “slider track” is a scroll bar or other type of panel that allows for the control of the level of a particular device setting. A slider nub may be aligned under the user's finger, while the rest of the user interface, including the slider track, may be located in a calculated position relative to the slider nub. As used herein, a “slider nub” is an indicator that appears on a device's screen to display the current position of a particular device setting relative to the slider track.

The calculated position of the rest of the user interface is determined such that the current value of the device setting is represented correctly by the position of the slider nub relative to the rest of the user interface. In addition, a tooltip may be displayed to indicate the current value of the particular device setting. The tooltip may appear adjacent to the finger or slider nub. A tooltip is a type of graphical user interface element that may consist of a small box containing information about a particular device setting. The tooltip may be updated in real-time to display the most current value of the particular device setting as the user adjusts the device setting.

In an embodiment, a particular device setting may be adjusted in response to a user dragging or sliding a finger across a touch input without releasing. A device setting may be changed in real-time as a user slides a finger up or down on a vertically-oriented slider, or left to right on a horizontally-oriented slider. For example, the volume or brightness of a screen on a device may be changed in real-time during video playback as a user moves a finger up or down on the screen. In addition, the tooltip may also follow the movement of the user's finger in order to reflect the current value of the particular device setting. In an embodiment, for a vertically-oriented slider, movement in the horizontal direction may be permitted but ignored. In other words, movement perpendicular to the slider axis may not dismiss the user interface but also may not affect the device setting.

In an embodiment, a particular device setting may be confirmed and set at a certain level in response to a user releasing a finger from a touch input on the device. Upon release, the entire user interface, including the fly-out hosting the slider and the tooltip, is dismissed. The new device setting value may be the last value indicated by the user prior to the release.

The quick scrub model disclosed herein allows for the benefits of real-time feedback. This may be particularly useful for applications in which quick adjustments between device setting levels are desired, such as video playback or audio control applications. The quick scrub model is also more efficient than the traditional fly-out model because the quick scrub model allows for the adjustment of device settings with a single, continuous motion, in comparison to the three motions required by the traditional fly-out model.

As a preliminary matter, some of the figures describe concepts in the context of one or more structural components, variously referred to as functionality, modules, features, elements, etc. The various components shown in the figures can be implemented in any manner, for example, by software, hardware (e.g., discreet logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discreet logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

FIG. 1 is a block diagram of a device 100 for adjusting device settings in response to a single motion. The device 100 may include a processor 102 that is adapted to execute stored instructions, as well as a storage device 104 that stores instructions that are executable by the processor 102. The processor 102 can include a single core processor, a multi-core processor, a computing cluster, or any number of other configurations. The processor 102 may be connected through a bus 106 to various devices, including the storage device 104.

The storage device 104 may be adapted to store a quick scrub model 108. The quick scrub model 108 may include the algorithm for adjusting device settings using a single, continuous scrubbing motion. The storage device 104 can include a hard drive, an optical drive, a thumbdrive, an array of drives, or any combinations thereof. The storage device 104 can also include memory. The memory can include random access memory (RAM), read only memory (ROM), flash memory, or any other suitable memory systems. The instructions implement a method that includes adjusting a device setting in response to a single motion.

An interface card 110 may be adapted to connect the device 100 through the bus 106 to a network 112. The interface card 110 may be a network interface card, a wireless interface card, or a cellular telephone interface card, among others. Through the network 112, electronic documents 114 may be downloaded and stored within the storage system 104. A human machine interface 116 within the device 100 may connect the device 100 to a keyboard 118, a pointing device 120, and a touch input 122. The keyboard 118, pointing device 120, and touch input 122 may be external, or may be integrated into the device 100, such as in a touchscreen. The pointing device 120 or touch input 122 may be used to control the device 100. The pointing device 120 may be a mouse, trackball, pointing stick, or joy stick, among others. The touch input 122 may be a touchscreen, touchpad, or any other type of touch-sensitive input. The touch input 122 may be controlled using a finger, stylus, or any other type of touch manipulator. In addition, other gesture-based input devices, such as wand-based input devices, glove-based input devices, or facial recognition devices, may also be used to control the device 100.

The device 100 may also be linked through the bus 106 to a display interface 124 adapted to connect the device 100 to a display device 126, wherein the display device 126 may include a computer monitor, camera, television, projector, cellular telephone, touchpad, interactive display device, or mobile device, among others. The display device 126 and touch input 122 may also be combined into a touch-sensitive display device, for example, that is integrated into the device 100. It should be understood that the device 100 may also be connected to any number of other input or output devices, including, for example, a printer, an imaging device, or speakers.

FIG. 2 is a process flow diagram showing a method 200 for adjusting device settings in response to a single motion. The method 200 employs a quick scrub model, as discussed above with relation to system 100. At block 202, an affordance, i.e., a device setting icon or entry point, is displayed on the device's screen. The affordance serves as a hit target for the user to initiate the interaction with the device. The affordance also includes an icon or status text that indicates the current value of the particular device setting.

At block 204, a user interface may be initiated in response to a tap down without releasing on a device setting icon using a touch input or pointing device. In an embodiment, a user interface may immediately appear beneath a user's finger in response to a user tapping down on a touch input without releasing. The user interface may consist of a fly-out that hosts a slider, including a slider track and slider nub. The slider nub may be aligned under the user's finger, while the rest of the user interface, including the slider track, is located in a calculated position relative to the slider nub. The calculated position of the rest of the user interface is determined such that the current value of the device setting is represented correctly by the position of the slider nub relative to the rest of the user interface. In addition, a tooltip may be displayed to indicate the current value of the particular device setting. The tooltip may appear adjacent to the finger or slider nub.

At block 206, a particular device setting may be adjusted in response to the dragging, or sliding, without releasing of a pointing device or a touch input on a device setting icon. A device setting may be changed in real-time as a user slides a finger up or down on a vertically-oriented slider, or left to right on a horizontally-oriented slider. For example, the volume or brightness of a screen on an imaging device may be changed in real-time during video playback as a user moves a finger up or down on the screen. In addition, the tooltip may also follow the movement of the user's finger in order to reflect the current value of the particular device setting. In an embodiment, for a vertically-oriented slider, movement in the horizontal direction may be permitted but ignored. In other words, movement perpendicular to the slider axis may not dismiss the slider but also may not affect the device setting.

At block 208, the device setting may be confirmed by releasing at the desired device setting level. In order to confirm the device setting, the tap down of a finger on a device setting icon using a touch input or the clicking of a device setting icon using a pointing device may be ceased. Upon release, the entire user interface, including the fly-out, slider, and tooltip, is dismissed. The new device setting value may be the last value indicated by the user prior to the release. At block 210, the icon or status text indicator of the affordance may be observed to validate that the desired device setting level has been set.

In an embodiment, a mouse may be used to implement the method 200. A user may tap down, or click, on a mouse without releasing, drag the mouse cursor across the slider menu until the desired device setting level is reached, and release. The current method 200 may also be implemented using any other type of pointing device or touch input in conjunction with a touch manipulator that allows for the carrying out of the steps at blocks 204, 206, and 208.

In an embodiment, the method 200 may also be used for the muting of the volume of a particular device. The muting may be accomplished by carrying out the method as indicated by blocks 204, 206, and 208. However, at block 206, the user may slide, or scrub, to the bottom of the vertically-oriented slider before releasing. This may effectively result in the muting of the device. In an embodiment, this may also be accomplished by a user simply flicking a finger downwards across a vertically-oriented slider on a device's touch screen. To unmute, the user may repeat the steps indicated by blocks 204, 206, and 208. However, at block 206, the user may scroll upwards across the vertically-oriented slider to unmute the device and adjust the volume to the desired level. In another embodiment, the method at blocks 204, 206, and 208 may be replaced by a single tap on the device setting icon to unmute the device and return the volume to the last level before muting. It should be understood that the same method may be used to mute or unmute the volume of a device using a horizontally-oriented slider, except a user may slide horizontally to one side of the slider to mute the volume and slide to the other side of the slider to unmute the volume at block 206. In addition, any other type of slider orientation may be acceptable, as long as the slider includes high and low, or on and off, settings.

FIG. 3 is a schematic illustrating a method for adjusting a volume setting of a device 300 in response to a single, continuous motion on a volume icon 302. FIG. 3A illustrates the touch-sensitive area 304 surrounding a volume icon 302 on the touchscreen of a device 300. In order to activate the user interface menu hosting the slider corresponding to the volume settings, a simple tap down on anywhere within the touch-sensitive area 304 may be sufficient. FIG. 3B illustrates the action of locating the volume icon and determining the appropriate touch-sensitive area to engage, as indicated by arrow 306.

FIG. 3C illustrates the action of tapping down on the touchscreen of the device 300 at the location of the volume icon 302 using a finger 308. A user interface menu 310, including a fly-out hosting a slider track 312 and slider nub 314, may immediately appear upon contact between the finger 308 and the touchscreen of the device 300. Also, the vertical position of the user interface 310 may be such that the slider nub 314 is located directly under the finger 308. The current value of the volume setting may be displayed by the tooltip 316 located adjacent to the user's finger 308.

FIG. 3D illustrates the sliding of the finger 308 up or down on the touchscreen of the device 300 in the location of the slider track 312. The slider nub 314 may remain directly underneath the finger 308 of the user at all times, and the tooltip 316 may display the changing value of the volume setting in real-time as it is adjusted.

FIG. 3E illustrates the confirmation of the new level for the device setting by removing the finger 308 from the touchscreen of the device 300. The user interface menu 310 may be immediately dismissed, and the device setting may remain at the last value indicated before removal of the finger 308. In addition, once the user interface menu 310 has been dismissed, the volume icon 302 becomes visible again.

It should be noted that the method is not limited to the use of a finger 308 but, rather, may employ the use of any type of touch manipulator or pointing device. In addition, the method may be used to adjust any device settings which consist of uniform and contiguous values.

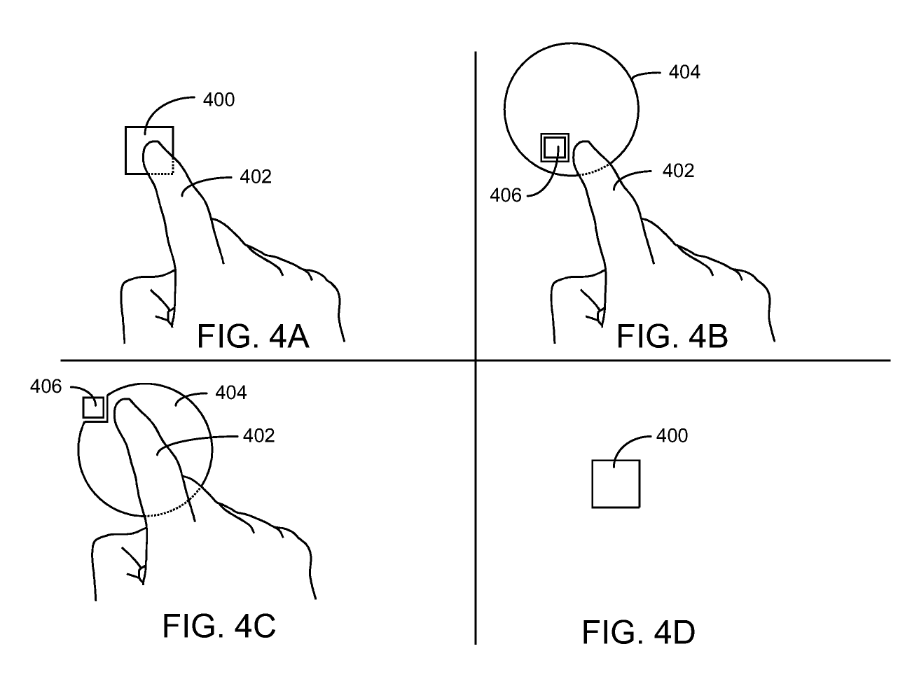

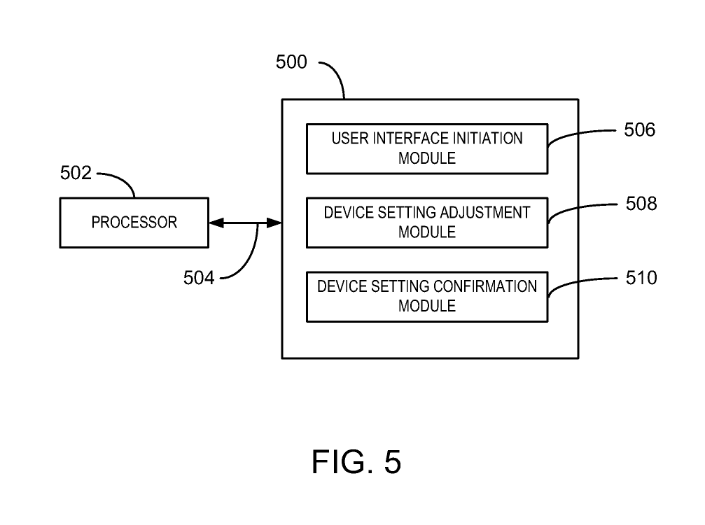

FIG. 4 is a schematic illustrating a method for adjusting a color setting of a device in response to a single, continuous motion on a color spectrum icon 400. FIG. 4A illustrates the use of a finger 402 as a touch manipulator to tap down on a color spectrum icon 400 on the touchscreen of a device.

FIG. 4B illustrates the appearance of a user interface menu 404 as a user taps down without releasing on a color spectrum icon 400, as discussed with respect to FIG. 4A. In this embodiment, the user interface menu 404 is a two-dimensional color wheel, which may be referred to as a two-dimensional, dual-axis picker. A tooltip 406 may also appear adjacent to or on top of the user interface menu 404.

FIG. 4C illustrates the movement of the user's finger 402 around the user interface menu 404 to adjust the color setting. The tooltip 406 may display the currently-selected color in real-time as the user moves the finger 402 around the color wheel. The position of the tooltip 406 may be continuously adjusted to remain close to the finger 400 as the user moves the finger 400 around the user interface menu 404.

FIG. 4D illustrates the immediate dismissal of the user interface menu 404 and reappearance of the color spectrum icon 400 upon release of the finger 402 from the touchscreen of the device. The new color setting may be indicated by the current color of the color spectrum icon 400. The new color setting may remain unchanged until the user adjusts the setting again by repeating the steps described with respect to FIGS. 4A-4C.

FIG. 5 is a block diagram showing a non-transitory computer-readable storage medium 500 that stores code adapted to adjust device settings in response to a single motion. The non-transitory computer-readable storage medium 500 may be accessed by a processor 502 over a computer bus 504. Furthermore, the non-transitory computer-readable storage medium 500 may include code configured to direct the processor 502 to perform the steps of the current method.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

The various software components discussed herein may be stored on the non-transitory computer-readable storage medium 500 as indicated in FIG. 5. For example, a user interface initiation module 506 may be configured to direct the processor 502 to initiate a user interface in response to a tap down without releasing on a device setting icon using a touch input or a pointing device. A device setting adjustment module 508 may be configured to direct the processor 502 to adjust a device setting in response to a dragging or sliding of the touch input or the pointing device on the device setting icon without releasing. Further, a device setting confirmation module 510 may be configured to direct the processor 502 to confirm the device setting by releasing the touch input or pointing device once a desired device setting level has been attained.

In an embodiment, a device may be configured to simultaneously support the quick scrub model and the traditional fly-out model, depending on the specific application. The device may be able to recognize specific gestures or commands which distinguish whether the user desires to interface with the quick scrub model or the traditional fly-out model. For example, a click and release of a mouse may indicate that the user desires to interface with the traditional fly-out model, while a click and hold of a mouse may indicate that the user desires to interface with the quick scrub model. The particular device may be configured to automatically recognize such gestures and initiate the quick scrub model or the traditional fly-out model accordingly.

In another embodiment, the user interface menu may immediately appear when the user taps down or clicks on the device setting icon. If the user begins to move the finger or mouse position within a predetermined amount of time of the appearance of the user interface menu, the device may initiate the quick scrub model. However, if the user does not move the finger or mouse position within a predetermined amount of time after the appearance of the user interface menu, the device may initiate the traditional fly-out model.

In yet another embodiment, the device may be configured to initiate the quick scrub model if the user invokes a particular device setting using a touch input, or to initiate the traditional fly-out model if the user invokes the device setting using a mouse or other pointing device. In this embodiment, each type of input device may be set to initiate either the traditional fly-out model or the quick scrub model.

In an embodiment, if a setting is not applicable or not available due to an error condition, the quick scrub model may display an indication that the setting is not available by greying-out the device setting icon or displaying status text that says “N/A.” Any attempt to scrub or otherwise invoke the user interface menu will be unsuccessful. In addition, pressing and holding on the device setting icon or hovering over the icon with a pointing device may initiate a tooltip. The tooltip may display the details of why the particular device setting is not available. For example, the tooltip may display a message such as “Desktop machines do not support adjusting brightness,” or “No speakers are connected.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for adjusting a device setting in response to a single motion, comprising:
initiating a user interface in response to a tap on a device setting icon without releasing;
adjusting a device setting in response to a movement on the device setting icon without releasing; and
confirming the device setting by releasing once a desired device setting level has been attained.

2. The method of claim 1, comprising adjusting the device setting for a mobile device, laptop computer, desktop computer, gaming device, television, cellular telephone, touchpad, interactive display device, or imaging device.

3. The method of claim 1, comprising determining the desired device setting to adjust, wherein the device setting comprises a brightness setting, volume setting, or any system or non-system setting that has uniform and contiguous values.

4. The method of claim 1, comprising tapping down on the device setting icon using a touch input, wherein the touch input comprises a touchscreen or touchpad that may be controlled using a finger, stylus, or other touch manipulator.

5. The method of claim 1, comprising tapping down on the device setting icon using a pointing device, wherein the pointing device comprises a mouse, trackball, pointing stick, or joy stick.

6. The method of claim 1, comprising initiating a user interface by pressing down and holding on the device setting icon using a touch input or clicking on the device setting icon without releasing using a pointing device.

7. The method of claim 1, comprising using a fly-out hosting a slider nub and a slider track to adjust the device setting, wherein the slider nub is positioned over the device setting icon at a point that is proportional to a current device setting level.

8. The method of claim 1, comprising using a tooltip to follow the movement of a slider nub and to display a changing value of the device setting in real-time as the device setting is adjusted.

9. The method of claim 1, comprising adjusting a device setting by dragging a pointing device in a direction without releasing a click or sliding across a touch input without removing a touch manipulator from a device.

10. The method of claim 9, comprising dragging or sliding in a vertical direction for a vertically-oriented slider or in a horizontal direction for a horizontally-oriented slider.

11. The method of claim 10, comprising permitting but ignoring dragging or sliding in the horizontal direction for the vertically-oriented slider or in the vertical direction for the horizontally-oriented slider.

12. The method of claim 1, comprising dragging or sliding in a horizontal and a vertical direction simultaneously for a two-dimensional slider, wherein the two-dimensional slider comprises a color wheel.

13. A system for adjusting a device setting in response to a single motion, comprising a processor configured to implement setting adjustment modules, wherein the modules comprise:
a user interface initiation module configured to initiate a user interface in response to a press without releasing on a device setting icon, wherein the user interface comprises a slider;
a device setting adjustment module configured to adjust a device setting in response to a dragging or sliding on the slider without releasing; and
a device setting confirmation module configured to confirm the device setting by releasing the slider once a desired device setting level has been attained.

14. The system of claim 13, wherein the device setting comprises a brightness setting, volume setting, or any setting that has uniform and contiguous values.

15. The system of claim 13, wherein the user interface comprises a tooltip, and wherein the tooltip comprises displayed information about the device setting that appears adjacent to the device setting icon.

16. The system of claim 15, wherein the tooltip displays a changing value of a device setting level as the device setting icon is adjusted.

17. The system of claim 13, wherein the quick scrub system may be used to mute or unmute a volume of a device using one continuous motion.

18. One or more non-transitory computer-readable storage media for storing computer-readable instructions, the computer-readable instructions providing a system for adjusting a device setting in response to a single motion when executed by one or more processing devices, the computer-readable instructions comprising code configured to:
initiate a user interface in response to a tap down without releasing on a device setting icon;
adjust a device setting in real-time in response to a sliding without releasing on the device setting icon;
set the device setting at a desired device setting level by releasing the device setting icon; and
abort the user interface upon release of the device setting icon.

19. The non-transitory computer-readable storage media of claim 18, wherein the computer-readable instructions comprise code configured to mute a volume setting of a device in response to a flick on a volume icon.

20. The non-transitory computer-readable storage media of claim 18, wherein the computer-readable instructions comprise code configured to unmute a volume setting of a device or return the volume setting to a previous value in response to a single tap on a volume icon.
